(19) United States
(12) Patent Application Publication
(10) Pub. No.: US 2018/0334360 A1
(43) Pub. Date: Nov. 22, 2018

(54) ELEVATOR SYSTEM HAVING A PLURALITY OF SHAFTS AND A PLURALITY OF CABS AND AN ADDITIONAL CAB-ACCOMMODATING SHAFT

(71) Applicants: THYSSENKRUPP ELEVATOR AG, Essen (DE); thyssenkrupp AG, Essen (DE)

(72) Inventors: Eduard STEINHAUER, Nürtingen (DE); Thomas KUCZERA, Leinfelden-Echterdingen (DE); Michael KIRSCH, Kirchheim unter Teck (DE); Stefan GERSTENMEYER, Filderstadt (DE); Markus JETTER, Filderstadt (DE); Patrick Michael BASS, Chicago, IL (US)

(73) Assignees: THYSSENKRUPP ELEVATOR AG, Essen (DE); thyssenkrupp AG, Essen (DE)

(21) Appl. No.: 15/552,561

(22) PCT Filed: Feb. 22, 2016
(86) PCT No.: PCT/EP2016/053658

§ 371 Date: Aug. 22, 2017

(30) Foreign Application Priority Data
Feb. 23, 2015 (DE) 10 2015 102 564.7

(51) Int. Cl. B66B 9/00; B66B 5/00

(52) U.S. Cl. CPC B66B 9/003; B66B 5/0087

(57) ABSTRACT

An elevator system may include a plurality of elevator banks that extend vertically over stories of a building, a plurality of cabs that are movable in the plurality of elevator banks and may change between elevator shafts of the plurality of elevator banks, and one or more cab-accommodating shafts for accommodating one or more of the cabs. The cab-accommodating shafts may extend vertically over fewer stories than one of the elevator shafts of the plurality of elevator banks. In some cases, elevator banks may be separated by a shaft-free intermediate space, and the cab-accommodating shafts may extend over the shaft-free intermediate space to connect multiple elevator shafts.

The present invention relates to an elevator system and to a method for operating an elevator system, with a number of elevator shafts extending vertically over a multiplicity of stories of a building comprising the elevator system, and with a number of cabs, which is designed to be moved in the number of elevator shafts and to change between elevator shafts of the first number of elevator shafts.

### PRIOR ART

In elevator systems having a plurality of elevator shafts, cabs can often change between said elevator shafts and be moved in a plurality of elevator shafts. High handling capacity (HC) can therefore be achieved, and a multiplicity of transport operations can be carried out, in particular simultaneously, by the elevator system. Elevator systems of this type are refereed to, for example, as shaft-changing multi-cab systems.

Maintenance or repair of individual cabs of an elevator system of this type is not readily possible. Often, individual elevator shafts or even the entire elevator system have/has to be taken out of operation in order to maintain individual cabs or to undertake repairs thereto. This is associated with a lot of effort and high costs.

When cabs are not maintained and have a defect during operation, there is the risk of said cabs becoming stuck in an elevator shaft. These defective cabs can obstruct the remaining cabs of the elevator system. This elevator shaft or the entire elevator system may have to be taken out of operation in order to remove or to repair the defective cab.

U.S. Pat. No. 3,658,155 presents an elevator system in which the shaft doors are set back one cab width from the travel path, and therefore cabs can pass by another cab in front of a door.

Transport operations of other cabs therefore do not have to be interrupted if a cab stops in front of a shaft door. However, maintenance of cabs is not possible there either.

EP 1 616 832 A2 discloses an elevator system with three or four elevator shafts lying directly next to one another. On account of the spatial proximity, a comprehensive changing of the elevator cabs between the individual elevator shafts is possible over a plurality of changing zones during the operation. Such a changing zone can be configured as a depot zone in which maintenance and repair operations are also carried out.

On account of structural specifications, the elevator shafts of modern skyscrapers are not always located in the direct vicinity to one another. Access regions to elevators are thus frequently designed as long hallways, on which the entries to the elevator shafts are provided on the right and left. Said hallways constitute a spatial separation of the elevator shafts arranged on the right and left of the hallway. Elevator shafts are frequently also located in different building tracts and are separated from one another here by a useable space and/or technical functional spaces.

It is the object of the present invention to increase the efficiency of elevator systems in the form of shaft-changing multi-cab systems.

### DISCLOSURE OF THE INVENTION

According to the invention, an elevator system and a method for operating an elevator system with the features of the independent patent claims are proposed. Advantageous refinements are the subject matter of the dependent claims and of the description below. Refinements and advantages of the elevator system according to the invention and of the method according to the invention emerge in an analogous manner from the description below.

The elevator system comprises a number of elevator shafts extending vertically over a multiplicity of stories of a building comprising the elevator system. A number of cabs are designed to be moved in the number of elevator shafts and to change between the elevator shafts of the number of elevator shafts. In other words, the elevator system comprises a shaft-changing multi-cab system.

The elevator system comprises one or more, i.e. at least one, additional cab-accommodating shaft for receiving at least one cab, which cab-accommodating shaft extends vertically over fewer stories than one of the elevator shafts of the number of elevator shafts, preferably than the lowest of the elevator shafts of the number of elevator shafts. The elevator system is preferably designed to move at least one cab of the number of cabs in the additional at least one cab-accommodating shaft and to store said cab there. The cab(s) mounted in the at least one cab-accommodating shaft is (are) in particular not available for transport operations in the number of elevator shafts.

A cab-accommodating shaft provides a multiplicity of possibilities in order to improve the operation of the elevator system. For example, maintenance and/or repair operations can be carried out in a cab-accommodating shaft. Defective cabs can be stored in a cab-accommodating shaft. Cabs which are not required can be parked in a cab-accommodating shaft. Individual cabs can be taken out of operation or deactivated and stored in a cab-accommodating shaft. Cabs stored in a cab-accommodating shaft can also be put into operation again and used for transport operations in the number of elevator shafts. A cab-accommodating shaft can be arranged at an expedient location or at suitable stories of the building comprising the elevator system. The elevator system can also comprise a plurality of cab-accommodating shafts of this type. The normal operation of the elevator system is not impaired here. Owing to the fact that this involves an additional cab-accommodating shaft, the latter can also be better separated structurally from the rest of the elevator system, in particular, for example, by (in particular fire-inhibiting or fireproof) doors or gates, and therefore the safety of the elevator system is not impaired by the storage or in particular maintenance of cabs in the cab-accommodating shaft.

The cabs are not allocated to specific elevator shafts, but rather can expediently be moved if required in particular in all of the elevator shafts of the number of elevator shafts. For this purpose, suitable connecting paths, for example in the form of horizontal elevator shafts, are provided between the elevator shafts of the number of elevator shafts. Connecting paths of this type can be provided, for example, only at certain locations or in certain stories of the building comprising the elevator system. Only certain elevator shafts of the number of elevator shafts can in each case be connected to one another, and therefore corresponding cabs can change only between said connected elevator shafts. However, all of the elevator shafts of the number of elevator shafts can also be connected to one another, and therefore in particular all of the cabs can change between all of the elevator shafts.

The invention is in particular usable in an elevator system which comprises a first number of elevator shafts and a second number of elevator shafts, wherein a shaft-free intermediate space is provided horizontally between the first number and the second number. This shaft-free intermediate space can be formed, for example, by a usable space, a technical functional space and/or or another traffic space, wherein the customary vertical elevator shafts are excluded from the other traffic space. The shaft-free intermediate space can in this respect comprise a horizontal extent between the numbers of the elevator shafts of at least 5 m, preferably at least 10 m. The numbers of elevator shafts are arranged in different building tracts, and therefore the distance can also be at least 40 m. At least one of the cab-accommodating shafts is now designed as an in particular horizontal connecting shaft which connects the first number to the second number by negotiating the shaft-free intermediate space.

By means of this connection, an interchanging of cabs from a number of elevator shafts that are spaced apart from one another can now also be carried out. By this means, resources of the individual numbers can be jointly used and therefore synergy effects created, although the elevator shafts can otherwise be arranged separately from one another and also operated separately from one another. In particular, it is thus possible to retain a single workshop (also see the description below regarding the maintenance region), into which the elevator cabs of the entire building can be moved and can then be maintained there. An adaptation of the quantity of cabs per number of elevator shafts can also be changed be changed for different operating modes, although the shafts are otherwise spatially separated from one another.

In particular, the cabs are in each case only moved upward in special elevator shafts of the number of elevator shafts and only downward in other elevator shafts of the number of elevator shafts. This resembles a circulating Pater-Noster operation.

At least one cab-accommodating shaft is advantageously designed as a maintenance region for the maintenance and/or repair of cabs of the elevator system. The at least one cab is advantageously maintained and/or repaired in the cab-accommodating shaft. In particular, sufficient tools and components for the maintenance and/or repair are provided in the cab-accommodating shaft. The cab-accommodating shaft in particular constitutes a service region. The cabs can be maintained or repaired automatically or else manually here. Over the course of the maintenance, it is checked in particular whether safety functions of the respective cab perform as required and satisfy predetermined safety guidelines.

Maintenance and/or repair operations can therefore be carried out on the cabs of the elevator system with little effort and low cost, without the entire elevator system or at least individual elevator shafts having to be taken out of operation. The elevator system can be operated regularly and nevertheless maintenance and/or repair operations can be carried out. For this purpose, cabs which are to be maintained or repaired are moved into the cab-accommodating shaft and maintained or repaired there, and the remaining cabs continue to operate regularly in the elevator shafts and carry out transport operations there. Regular maintenance and simple repair of the cabs of the elevator system can therefore be made possible. The risk of cabs having a defect during regular operation can be reduced.

If the cab-accommodating shaft is of a size sufficient to store a plurality of cabs therein, or if the elevator system comprises a plurality of cab-accommodating shafts, a multiplicity of cabs can be maintained or repaired at the same time. Maintenance or repair operations can therefore be carried out even more rapidly and effectively.

Preferably, a brake system of the at least one cab is maintained in a cab-accommodating shaft. For example, brakes can be tested and checked as to whether they satisfy predetermined safety guidelines. For example, brake linings can be changed.

Preferably, a guide roller of the at least one cab is changed in a cab-accommodating shaft. In particular, guide rollers which have a high degree of wear can be replaced.

The at least one cab is advantageously moved at predetermined maintenance intervals into a cab-accommodating shaft and maintained there. The maintenance interval can be, for example, a day or else a week. Regular, weekly or even daily maintenance of the cabs can therefore be made possible. In particular, automatic or fully automatic maintenance of the cabs is therefore realized. In particular, all of the cabs of the elevator system are moved after expiry of their maintenance interval into a cab-accommodating shaft and maintained.

The at least one cab is preferably moved depending on operating parameters of the elevator system into a cab-accommodating shaft and stored there. Individual cabs can therefore be taken out of operation in accordance with defined criteria and stored in the cab-accommodating shaft. For example, cabs which are not required for transport operations in the respective number of elevator shafts can be stored in the cab-accommodating shaft. The operating parameters can in particular provide information about how many cabs are required for carrying out the transport operations. For example, the operating parameters can provide information about a required handling capacity (HC), i.e. a required handling capacity for carrying out all of the transport operations.

A cab-accommodating shaft preferably has an interior space, the greatest horizontal expanse of which is greater than the greatest vertical expanse thereof. In other words, the cab-accommodating shaft extends substantially horizontally or vertically to the elevator shafts of the elevator system. This is particularly space-saving in the vertical direction. Said cab-accommodating shaft can simultaneously extend vertically over the height of a story or else, in the manner of a maintenance or storage depot, over a plurality of stories of the building comprising the elevator system. In particular, cabs can be moved only horizontally, but not vertically, within the horizontally extending cab-accommodating shaft. In particular, a plurality of cabs can be stored next to one another in the horizontally extending cab-accommodating shaft.

A cab-accommodating shaft likewise preferably comprises an interior space, the greatest horizontal expanse of which is smaller than the greatest vertical expanse thereof. In other words, the cab-accommodating shaft extends substantially vertically or parallel to the elevator shafts of the elevator system. This is particularly space-saving in the horizontal direction. In particular, cabs can be moved only vertically, but not horizontally, within said vertically extending cab-accommodating shaft. In particular, a plurality of cabs can be stored one above another in the vertically extending cab-accommodating shaft.

A cab-accommodating shaft preferably at least partially extends over a basement of a building comprising the elevator system. In buildings, the basement is often not accessible to visitors of the building and is therefore suitable for possibly loud maintenance operations. The space used there for the cab-accommodating shaft is also cost-effective since the space does not have to be withdrawn from valuable commercial, office or living areas. The cab-accommodating shaft can therefore be arranged inconspicuously and in a space-saving manner in the basement.

A cab-accommodating shaft advantageously at least partially extends over an equipment floor or over a service level of a building comprising the elevator system. This equipment floor is provided in particular for maintenance, repair and/or service operations and is customarily also not accessible to visitors. It is therefore suitable for possibly loud maintenance operation. The space used there for the cab-accommodating shaft is also cost-effective since it does not have to be withdrawn from valuable commercial, office or living areas. In particular, suitable tools are stored in the technical floor. The technical floor is provided in particular for machines or systems for servicing the building comprising the elevator system. For example, an air-conditioning system, a ventilation system, a heating system, and power and/or water servicing of the building can be arranged on the technical floor.

In an advantageous development, the elevator system comprises a first number and a second number of elevator shafts extending vertically over a multiplicity of stories of the building comprising the elevator system. A first number of cabs is designed to be moved in the first number of elevator shafts and to change between the elevator shafts of the first number of elevator shafts. Similarly, a second number of cabs is designed to be moved in the second number of elevator shafts and to change between the elevator shafts of the second number of elevator shafts. Transport operations in the first number of elevator shafts are carried out by the first number of cabs, and transport operations in the second number of elevator shafts are carried out by the second number of cabs. In other words, this embodiment of the elevator system comprises two shaft-changing multi-cab systems. The at least one cab-receiving shaft is designed as a connecting shaft which connects the first number of elevator shafts and the second number of elevator shafts in a cab-exchanging manner.

The statements made above regarding the number of elevator shafts and the number of cabs also advantageously apply to the first and second number of elevator shafts and cabs.

Further advantages and refinements of the invention emerge from the description and the attached drawing.

It goes without saying that the features mentioned above and those which have yet to be explained below are usable not only in the respectively stated combination, but also in other combinations or on their own without departing from the scope of the present invention.

The invention is illustrated schematically in the drawing with reference to exemplary embodiments and is described below with reference to the drawing.

### DESCRIPTION OF THE FIGURES

FIGS. 1 and 2 each schematically show a preferred refinement of an elevator system according to the invention which is designed in each case to carry out a preferred embodiment of a method according to the invention.

FIG. 3 shows a further preferred refinement of an elevator system according to the invention which is designed to carry out a preferred embodiment of a method according to the invention.

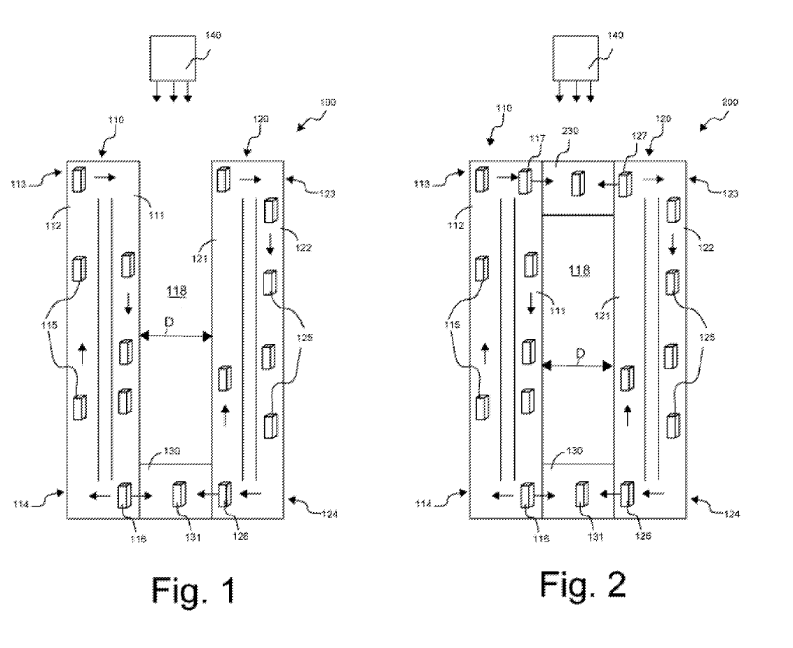

A preferred embodiment of an elevator system according to the invention is illustrated schematically in FIG. 1 and denoted by 100. The elevator system 100 is designed to carry out a preferred embodiment of a method according to the invention.

The elevator system 100 comprises a first number 110 of vertically extending elevator shafts 110. In this example, two elevator shafts 111 and 112 form the first number of elevator shafts 110. The elevator shafts 111 and 112 are connected to each other via connecting paths 113 and 114. The connecting paths 113, 114 are arranged in an uppermost or in a lowermost story of a building comprising the elevator system 100. The lowermost story is, for example, a basement, and the uppermost story is, for example, the tenth story.

A first number of cabs 115 is movable in the first number of elevator shafts 110. The cabs 115 can change between the elevator shafts 111 and 112 via the connecting paths 113 and 114. In the elevator shaft 112, the cabs 115 are moved, for example, only upward, and, in the elevator shaft 111, for example only downward. In the first number of elevator shafts 110, the cabs 115 are operated as a first shaft-changing multi-cab system.

The elevator system 100 furthermore comprises a second number of vertically extending elevator shafts 120. Two elevator shafts 121 and 122 form this second number of elevator shafts 120. Analogously to the elevator shafts 111 and 112, the elevator shafts 121 and 122 are also connected to each other via connecting paths 123 and 124.

Analogously to the first number of elevator shafts 110, a second number of cabs 125 is movable in the second number of elevator shafts 120. The cabs 125 can change between the elevator shafts 121 and 122 via the connecting paths 123 and 124. In the elevator shaft 121, the cabs 125 are moved, for example, only upward, and, in the elevator shaft 122, for example only downward. In the second number of elevator shafts 120, the cabs 125 are operated as a second shaft-changing multi-cab system.

Arranged between the first number 110 and the second number 120 is a shaft-free intermediate space 118 in which, for example, offices, hallways, domestic installation rooms, etc. are provided. A smallest distance D between the elevator shaft 111 of the first number 110, which elevator shaft is arranged closest to the second number 120, and the elevator shaft 113 of the second number 120, which elevator shaft is arranged closest to the first number 110, is, for example, 5 m. On virtually all levels, a hallway in this example is designed as a traffic area.

A cab-accommodating shaft designed here as a connecting shaft 130 for accommodating at least one cab connects the first and the second number of elevator shafts 110 and 120 to each other in a cab-guiding manner. Individual cabs both of the first number of cabs 115 and of the second number of cabs 125 can move into said connecting shaft 130 and can be stored there.

In this example, the connecting shaft 130 is designed as a horizontally extending elevator shaft. The connecting shaft 130 is arranged in the basement of the building comprising the elevator system 100.

If a cab of the first number of cabs 115 is located in the elevator shaft 111 and in the basement, said cab can be moved into the connecting shaft 130. This is a cab 116 in FIG. 1. Analogously, a cab of the second number of cabs 125 can be moved into the connecting shaft 130 if said cab is located in the elevator shaft 121 and in the basement. This is a cab 126 in FIG. 1.

In the example illustrated by FIG. 1, a cab 131 is located in the connecting shaft and is stored there. For example, said cab 131 can be a cab of the first number of cabs 115. In the example of FIG. 1, the connecting shaft 130 provides sufficient space to store three cabs next to one another.

The connecting shaft 130 is furthermore designed as a maintenance region for the maintenance and repair of cabs of the elevator system 100. In particular, regular automatic maintenance of the cabs 115 and 125 of the elevator system 100 is made possible by means of the connecting shaft 130. The connecting shaft 130 also in particular has entries for maintenance personnel. The maintenance of cabs can therefore be carried out in particular also manually. In the example of FIG. 1, up to three cabs next to one another in the connecting shaft 130 can be simultaneously stored and maintained.

For this purpose, all of the cabs 115 and 125 of the elevator system are moved at predetermined maintenance intervals into the connecting shaft 130 and maintained there. If, during the course of the maintenance, a defect on one of the cabs is established, a repair of the corresponding cab is carried out. The maintenance interval may be, for example, a day, and therefore all of the cabs 115 and 125 of the elevator system 100 are maintained daily. It is therefore possible to prevent cabs of the elevator system 100 failing during regular operation and possibly obstructing other cabs.

When one or more cabs are maintained in the connecting shaft 130, the remaining cabs of the elevator system 100 are moved in the meantime in the respective elevator shafts 111, 112, 21 or 122 over the course of regular transport operations.

Despite the spatial separation of the first number 110 and the second number 120 of elevator shafts, a single maintenance region suffices to maintain and repair all of the cabs of the elevator system.

The elevator system 100 furthermore in particular comprises a control unit 140 which is designed to activate the individual cabs 115 and 125 of the elevator system 100.

Furthermore, the control unit 140 is designed in particular to carry out a preferred embodiment of the method according to the invention. In particular, the control unit 140 is designed to move the individual cabs 115 and 125 after expiry of the respective maintenance interval into the connecting shaft 130 and to automatically maintain them there.

A further preferred refinement of the elevator system according to the invention is illustrated schematically analogously to FIG. 1 in FIG. 2 and denoted by 200. The same reference signs in FIGS. 1 and 2 denote identical or structurally identical elements.

In addition to the connecting shaft 130, the elevator system 200 comprises a cab-accommodating shaft which is designed here as a second connecting shaft 230. Said second connecting shaft is arranged, for example, in the uppermost, tenth story of the building comprising the elevator system 100. For example, said uppermost story can be designed as a technical floor or as a service level.

The second connecting shaft 230 is designed in particular analogously to the connecting shaft 130 likewise as a horizontally extending elevator shaft and furthermore as a maintenance region for the maintenance and repair of cabs of the elevator system 100.

If a cab of the first number of cabs 115 is located in the elevator shaft 111 and on the uppermost story, said cab can be moved into the connecting shaft 230. This is a cab 117 in FIG. 1. Analogously, a cab of the second number of cabs 125 can be moved into the connecting shaft 230 if said cab is located in the elevator shaft 121 and on the uppermost story. This is a cab 127 in FIG. 1.

The second connecting shaft 230 likewise provides space, for example, in order to store three cabs next to one another. A total of up to six cabs can therefore be stored and/or maintained simultaneously in the connecting shafts 130 and 230.

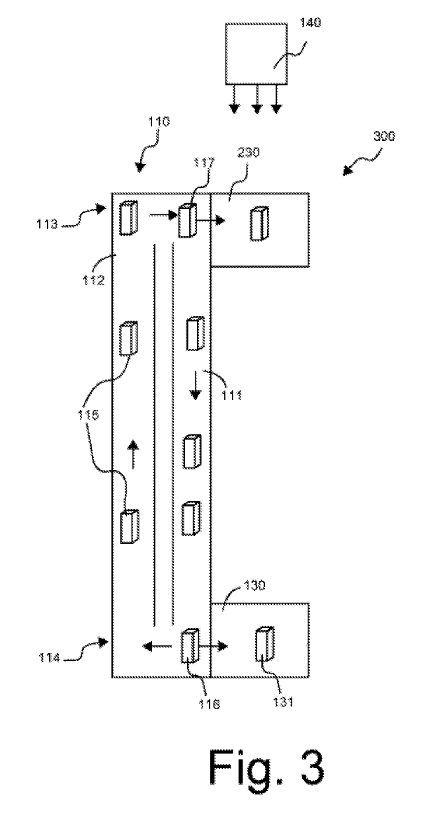

FIG. 3 illustrates a further preferred embodiment 300 of an elevator system, which substantially corresponds to the elevator system 200 according to FIG. 2, but instead of two comprises just one shaft-changing multi-cab system 110. Accordingly, the cab-accommodating shafts 130, 230 are also not designed as connecting shafts. All other advantages and properties which have been described with respect to the elevator system 200 also apply to the elevator system 300.

The cab-accommodating shafts 130, 230 of all of the elevator systems 100, 200 and 300 shown constitute in particular shafts which are separated structurally from the remaining elevator shafts 111, 112, 121 and 122 and which are in particular also separable from the remaining elevator shafts 111, 112, 121, for example by means of a door. Said door can be, for example, of fireproof design. The cab-accommodating shafts 130, 230 in particular also comprise entry doors for maintenance personnel.

### LIST OF REFERENCE SIGNS

100 Elevator system
110 First number of vertically extending elevator shafts
111 Elevator shaft
112 Elevator shaft
113 Connecting path between elevator shafts
114 Connecting path between elevator shafts
115 First number of cabs
116 Cab
117 Cab
118 Shaft-free intermediate space
120 Second number of vertically extending elevator shafts
121 Elevator shaft
122 Elevator shaft
123 Connecting path between elevator shafts
124 Connecting path between elevator shafts
125 Second number of cabs
126 Cab
127 Cab
130 Connecting shaft, cab-accommodating shaft
140 Control unit
200 Elevator system
230 Second connecting shaft, cab-accommodating shaft
300 Elevator system

1.-14. (canceled)

15. An elevator system comprising:
a plurality of elevator banks extending vertically over stories of a building, each of the plurality of elevator banks including a plurality of elevator shafts;
a plurality of cabs that are movable in the plurality of elevator banks and movable between the plurality of elevator shafts of the plurality of elevator banks; and
a cab-accommodating shaft that accommodates at least one of the plurality of cabs, wherein the cab-accommodating shaft extends vertically over fewer of the stories of the building than one of the plurality of elevator shafts of the plurality of elevator banks.

16. The elevator system of claim 15 wherein the plurality of elevator banks comprises a first elevator bank and a second elevator bank, wherein the first and second elevator banks are separated horizontally by a shaft-free intermediate space, wherein the cab-accommodating shaft is configured as a connecting shaft that extends over the shaft-free intermediate space and connects the first and second elevator banks.

17. The elevator system of claim 16 wherein the shaft-free intermediate space comprises at least one of usable space, technical functional space, or traffic space, wherein the shaft-free intermediate space comprises a horizontal expanse between the first and second elevator banks of at least 5 m.

18. The elevator system of claim 15 wherein the cab-accommodating shaft is configured as a maintenance shaft for at least one of maintaining or repairing the plurality of cabs.

19. The elevator system of claim 15 wherein the cab-accommodating shaft comprises an interior space, wherein a greatest horizontal extent of the interior space is larger than a greatest vertical extent of the interior space.

20. The elevator system of claim 15 wherein the cab-accommodating shaft extends at least partially over a basement of the building.

21. The elevator system of claim 15 wherein the cab-accommodating shaft extends at least partially over an equipment floor of the building.

22. The elevator system of claim 15 wherein the cab-accommodating shaft is configured to store at least one the plurality of cabs.

23. The elevator system of claim 15 wherein the plurality of elevator banks comprises a first elevator bank and a second elevator bank, wherein the plurality of cabs comprises a first plurality of cabs and a second plurality of cabs, wherein the first plurality of cabs is configured to be moved in the first elevator bank and change between the plurality of elevator shafts of the first elevator bank, wherein the second plurality of cabs is configured to be moved in the second elevator bank and change between the plurality of elevator shafts of the second elevator bank, wherein the cab-accommodating shaft is a connecting shaft that connects the first elevator bank to the second elevator bank.

24. A method of operating an elevator system that comprises a plurality of elevator banks extending vertically over stories of a building, a plurality of cabs that are movable in the plurality of elevator banks and movable between a plurality of elevator shafts of at least one of the plurality of elevator banks, and a cab-accommodating shaft that accommodates at least one of the plurality of cabs and extends vertically over fewer of the stories of the building than one of the plurality of elevator shafts of the plurality of elevator banks, the method comprising:
moving at least one of the plurality of cabs into the cab-accommodating shaft; and
storing the at least one of the plurality of cabs in the cab-accommodating shaft.

25. The method of claim 24 further comprising at least one of maintaining or repairing the at least one of the plurality of cabs in the cab-accommodating shaft.

26. The method of claim 24 further comprising moving the at least one of the plurality of cabs into the cab-accommodating shaft at predetermined maintenance intervals.

27. The method of claim 24 further comprising:
moving the at least one of the plurality of cabs into the cab-accommodating shaft depending on operating parameters of the elevator system; and
storing the at least one of the plurality of cabs in the cab-accommodating shaft.

28. The method of claim 24 further comprising:
moving the plurality of cabs only upwards in a first of the plurality of elevator shafts of the at least one of the plurality of elevator banks; and
moving the plurality of cabs only downwards in a second of the plurality of elevator shafts of the at least one of the plurality of elevator banks.

29. An elevator system comprising:
an elevator bank extending vertically over stories of a building, wherein the elevator bank includes a plurality of elevator shafts;
a plurality of cabs that are movable in the elevator bank and movable between the plurality of elevator shafts of the elevator bank; and
a cab-accommodating shaft that accommodates at least one of the plurality of cabs, wherein the cab-accommodating shaft extends vertically over fewer of the stories of the building than one of the plurality of elevator shafts of the elevator bank.

30. The elevator system of claim 29 wherein the elevator bank is a first elevator bank, the elevator system further comprising a second elevator bank that includes at least one elevator shaft, wherein the cab-accommodating shaft connects the first and second elevator banks.

31. The elevator system of claim 30 wherein the cab-accommodating shaft is a first cab-accommodating shaft, the elevator system further comprising a second cab-accommodating shaft that connects the first and second elevator banks, wherein the second cab-accommodating shaft is vertically spaced apart from the first cab-accommodating shaft and is disposed above or below the first cab-accommodating shaft.

32. The elevator system of claim 29 wherein the cab-accommodating shaft is a first cab-accommodating shaft, the elevator system further comprising a second cab-accommodating shaft that is vertically spaced apart from the first cab-accommodating shaft and is disposed above or below the first cab-accommodating shaft.

33. The elevator system of claim 29 wherein the elevator bank is a first elevator bank, the elevator system further comprising a second elevator bank, wherein the first and second elevator banks are separated horizontally by a shaft-free intermediate space, wherein the cab-accommodating shaft extends over the shaft-free intermediate space and connects the first and second elevator banks.

34. The elevator system of claim 33 wherein the cab-accommodating shaft comprises an interior space, wherein a greatest horizontal extent of the interior space is larger than a greatest vertical extent of the interior space.
